(19) United States
(12) Patent Application Publication
(10) Pub. No.: US 2011/0137761 A1
(43) Pub. Date: Jun. 9, 2011

(54) METHOD FOR DETECTING FRAUDULENT TRANSACTIONS BETWEEN PRACTICE MANAGEMENT AND ACCOUNTING SOFTWARE

(75) Inventors: Steven E. McDermott, West Jordan, UT (US); Ernie Kim, West Jordan, UT (US)

(73) Assignee: MCKEAN ENTERPRISES, L.L.C., Salt Lake City, UT (US)

(21) Appl. No.: 12/789,336

(22) Filed: May 27, 2010

Related U.S. Application Data
(60) Provisional application No. 61/181,477, filed on May 27, 2009.

(51) Int. Cl. G06Q 40/00

(52) U.S. Cl. 705/30

(57) ABSTRACT

A method for detecting fraudulent transactions includes acquiring transaction data entered into an accounting software program and a practice management software program by a monitoring software program. The monitoring software program can be configured to detect any unusual activity in the acquired transaction data and to store detected unusual activity for later review. The monitoring software can be directed to notify a responsible party that unusual activity has been found in the originally acquired data. The monitoring software can be configured to format the acquired data and the data of the unusual activity into a report reviewable by the responsible party.

### PRIORITY CLAIM

Priority is claimed to copending U.S. Provisional Patent Application Ser. No. 61/181,477, filed May 27, 2009, which is hereby incorporated herein by reference in its entirety.

### BACKGROUND

To assist with financial and accounting matters, many small businesses use computer software programs that can manage accounting transactions and simplify the bookkeeping process. Unfortunately, most of these accounting programs can be susceptible to fraudulent bookkeeping practices.

Fraudulent activities such as embezzlement through falsified accounting practices have long been a problem for many businesses, but especially smaller professional businesses, such as dental practices, medical practices, legal practices, and other sole proprietorships or partnerships. Often these types of smaller businesses are susceptible to such fraudulent activities because they do not have access to accounting resources that are capable of implementing fraud protection protocols. The accounting systems of these types of businesses are often not monitored or well regulated because the business owner does not have the ability and/or desire to track accounts receivable transactions, invoices paid, deposits, and other business transactions. Consequently, embezzlement can occur through skimming of cash payments, diverting funds to dummy accounts, and other common fraud methods.

Additionally, when fraud or embezzlement is suspected, smaller businesses often have a difficult time reporting such crimes because the financial data showing the criminal activity is difficult to gather, analyze, and report. Because of the time needed to gather the evidence and file a properly documented police report, even when suspicious activity is reported, busy police departments may have difficulty responding without clear and convincing evidence that such a crime has been committed.

### SUMMARY

The invention provides a method for detecting fraudulent transactions including acquiring transaction data entered into an accounting software program and a practice management software program by a monitoring software program. The monitoring software program can be configured to detect any unusual activity in the acquired transaction data and to store detected unusual activity for later review. The monitoring software can be directed to notify a responsible party that unusual activity has been found in the originally acquired data. The monitoring software can also be configured to format the acquired data and the data of the unusual activity into a report reviewable by the responsible party.

The method can also include configuring the monitoring software to allow the responsible party to direct the monitoring software to populate an affidavit and police report with the acquired data, the stored detected changes data, and the predetermined acceptable range data.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a decision tree flow chart showing a method for detecting fraudulent transactions in accordance with an embodiment;

FIG. 2 is a schematic diagram of a networked computer system configured to detect fraudulent transactions in accordance with the method of FIG. 1;

FIG. 3 is a flow chart showing a method for detecting fraudulent transactions and providing acquired data in a reviewable report in accordance with another embodiment;

FIG. 4 is a flow chart showing a method for detecting fraudulent transactions and allowing resolution of unusual activity in accordance with another embodiment; and

FIG. 5 is a flow chart showing a method for detecting fraudulent transactions and creating a police report in accordance with another embodiment.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The inventors of the present invention have recognized that it would be advantageous to develop a method for monitoring business accounting and practice management software for fraudulent bookkeeping and accounting practices and/or errors. Additionally, the inventors of the present invention have recognized that it would be advantageous to develop a method for automatically detecting fraudulent accounting transactions, notifying a responsible party, and providing evidence of the activity to the police.

A system and method is provided for protection against fraudulent transactions in accounting, practice management, bookkeeping software programs, and procedures for businesses, especially small business such as sole proprietorships, personal corporations, and partnerships, like dental offices, doctor offices, legal practices, and the like. The method for protecting against fraud can include accessing transaction data from an accounting database and practice management database with a monitoring software program.

The monitoring software program can monitor the transactions entered into accounting or practice management programs throughout the day during use of the software. Monitoring can take place either continuously or periodically at set intervals. The monitoring program can be configured to detect unusual transaction activity such as changes in accounts receivable data after initial entry, accounts receivable entries below an expected value, deposit transactions that do not match accounts receivable transaction data, and the like. The monitoring program can record and store the data associated with the unusual transaction activity for later review.

The monitoring program can also be configured to notify a responsible party, such as the business owner, dentist, office manager, and the like, regarding the status of the transactions entered into the accounting or practice management programs during the monitoring period. For example, if no unusual activity has been detected during the monitoring period, a message can be sent to the responsible party that no unusual activity has been detected. Additionally, if unusual activity, such as any of the unusual activities described in the previous paragraph, has been detected during the monitoring period, a message can be sent to the responsible party that the data should be reviewed and the unusual activity investigated and/or resolved. The monitoring program can send messages to the responsible party by any electronic method known in the art, such as email, text messaging, instant messaging, voice mail and the like. The term “resolved”, as used herein can mean to clarify or understand why the activity was recognized as unusual and to take necessary actions to correct the unusual activity. For example, if activity was recognized as unusual, but was not unusual or was expected, the responsible party may take no further action. If the activity was unusual and a cause for concern for the responsible party, the responsible party may perform an investigation into the accounting practices and/or activities of a bookkeeper or bookkeeping system and take steps to correct the situation and prevent future unusual activity.

The monitoring program can also be configured to analyze and report the monitored transaction data in a variety of formats. For example, the monitoring program can be used to create reports or documentation such as police reports, affidavits, or other evidentiary documentation. Such reports and documentation can be created by the responsible party, for instance, if the unusual transaction activity can not be resolved and the reports and documentation can be used by police in fraud and embezzlement investigations.

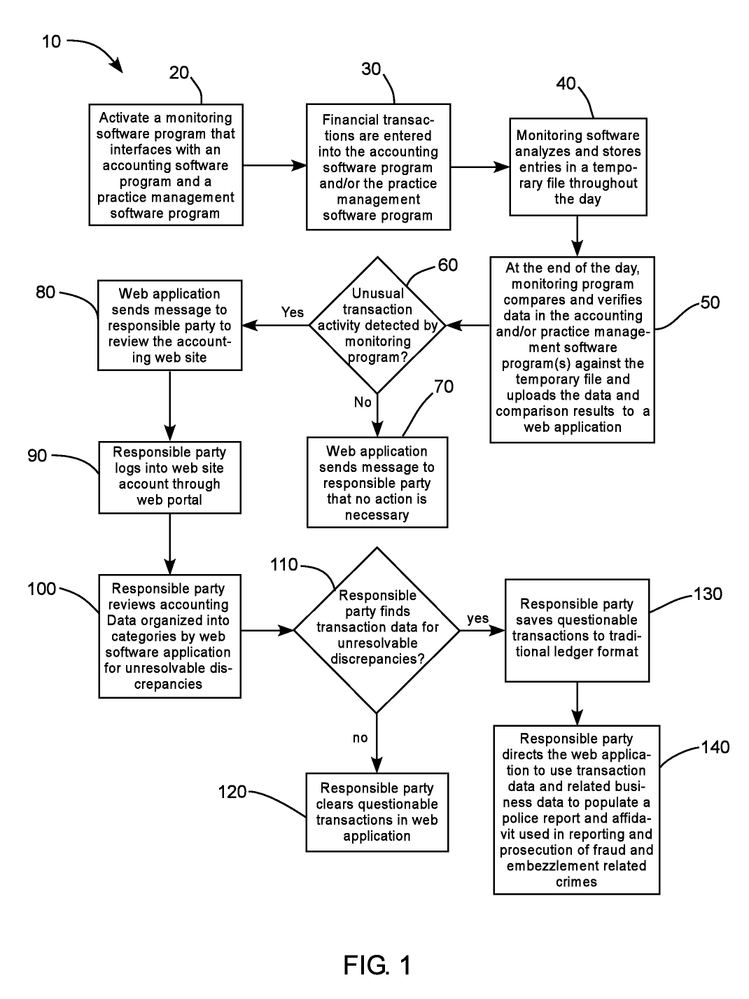

In an embodiment illustrated in FIG. 1, a method for detecting fraudulent transactions, indicated generally at 10, is shown for use in helping businesses track accounts receivable and other financial transactions. The method includes activating or executing a monitoring software program on the local computer server of a business or other location, as shown at 20. The monitoring program can interface with an accounting or bookkeeping database and/or software program that resides on the business's local computer server. Specifically, the monitoring program can interface with the accounting software or the practice management software through an application programming interface (API) or a software development kit (SDK) that provided by the accounting software or the practice management software. The accounting software program can be third party software, as known in the art, or a software program native to and bundled with the monitoring software. Some examples of third party software may include QuickBooks® Peachtree®, or Quicken®, etc. The monitoring program can also interface with practice management software, such as EagleSoft®, Practice Works®, Dentrix®, etc. The monitoring program can access data entered into the accounting or practice management software by using security credentials, such as a username and password to communicate with the accounting or practice management software.

Financial transactions can be entered into the accounting software program, as shown at 30. Additionally, client, customer, or patient information can be entered into software programs or databases that can be accessible to the monitoring program. Financial transactions and other information can likewise be entered into practice management software.

The monitoring software can analyze and record data entered into the accounting program, as shown at 40. The recorded data can be stored in electronic files for use in later comparison analysis by the monitoring software. In one aspect, the electronic files may be temporary. Similarly, the monitoring software can analyze and record data entered into the practice management program. Such data can also be recorded and stored in electronic files. At the end of the day, at the close of business, or at any other suitable or convenient time, the monitoring program can compare and verify data in the accounting program against data in the temporary file, as shown at 50. The comparison data and results can be uploaded to a web application residing on a server. In one aspect, the server can be an internet based server.

In one embodiment, the monitoring software can collect data from both practice management and accounting programs. The monitoring software can be configured to take a snapshot of the data entered into the practice management program (usually done at a point of service) and compare the data from the practice management program to corresponding entries in the accounting program when the accounting program is closed out for the day. For example, the monitoring software can compare a data snapshot from the accounting program to a data snapshot from the practice management program for discrepancies. If discrepancies are found, the monitoring software can move, copy, flag or otherwise record such discrepancies on or to the web application or web server for review by the responsible party. Studies have shown that deletions and modifications of transactions or data entries associated with embezzlement techniques are often between when practice management data is sent to the front office and when the accounting program entries are made.

The web application can determine whether any unusual transaction activity was detected by the comparison analysis, as shown at 60. If no unusual activity was detected, the web application can send a message to a responsible party that as of the close of business no action is necessary regarding the data uploaded to the web application, as shown at 70. If unusual activity is detected, the web application can send a message to the responsible party giving instructions to review the uploaded accounting data on the web application. The responsible party can access the data through an internet or web based portal, as shown at 80. Messages sent to the responsible party from the web application can be sent by any electronic method known in the art, such as email, text message, instant message, voice mail and the like. In another embodiment, the functions of the web application can instead be performed by the monitoring software.

In one embodiment, the web application or monitoring software not only provides the data and notice of unusual activity to the responsible party, but additionally may provide information such as: a reason the activity was detected as unusual; what specific information in the data appears unusual; why the data is unusual; and suggestions for the responsible party to correct the situation.

After receiving instructions to review the accounting data, the responsible party can access the data, such as by logging into an account on the web server through a web portal, as shown at 90. When logged into the account, the responsible party can review the uploaded accounting data. The uploaded accounting data can be organized into categories by the web application, as shown at 100. The responsible party can review the data for unexplainable or unresolvable accounting discrepancies found during the comparison analysis, as shown at 110. As used herein, a “discrepancy” may refer to any event or information that departs from expectations. Such unresolvable accounting discrepancies may include changes in accounts receivable data after initial entry, accounts receivable entries below an expected value, deposit transactions that do not match accounts receivable transaction data, and the like.

If the responsible party does not find unexplainable or unresolvable discrepancies, the responsible party can clear the unusual activity flagged by a comparison analysis engine in the web application, as shown at 130. If the responsible party does find unexplainable or unresolvable transactions, the responsible party can direct the web application to provide or save the questionable transaction data in a ledger format, as shown at 140. According to embodiments, the monitoring software can be configured with greater or lesser sensitivity in determining what activities comprise unusual activity. Also, as more and more data is collected, the system can become smarter in determining what is actual suspicious activity. In other words, business logic used by the monitoring software to identifies suspicious activity can get “smarter” and can learn what activities to ignore and what activities to monitor based on a history of what has been logged, what has been finally determined to be suspicious, and what has been cleared as being not unusual activity.

The responsible party can direct the web application to use the transaction data and related business data collected by the monitoring program to populate any of a variety of types of reports and documentation. For example, a police report, affidavit, and other evidentiary documentation may be created, as shown at 150. The documentation can then be delivered to an investigative law enforcement authority, such as a police officer, detective, or the like, to initiate a formal law enforcement investigation. In one embodiment, the documentation may be delivered to a law enforcement authority electronically.

In one embodiment, the monitoring software can collect data from the practice management and/or accounting programs by monitoring data entry via key strokes. For example, the monitoring software can be configured to collect information entered into the accounting software or the practice management software as it is entered. The monitoring program can further be configured to determine what entries represent account information, what entries represent financial information, etc. in order to organize and/or make sense of the data entries. This embodiment may preclude the need for directly accessing the accounting software or the practice management software or the databases managed by these software.

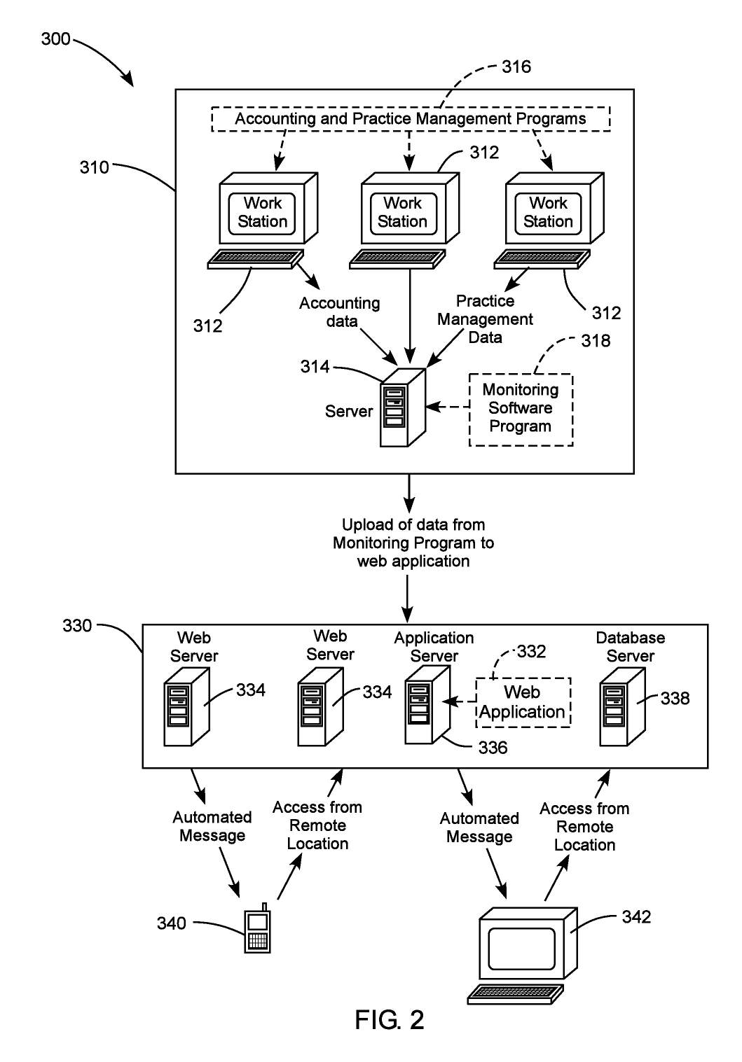

Referring to FIG. 2, a computer network system, in accordance with another embodiment and indicated generally at 300, is shown for use with the method 10 described above and shown in FIG. 1. The computer network system can include a local computer network 310 that resides in a place of business such as a dental office, doctor's office, law office or the like. The local computer network 310 can include at least one work station 312 or client that can be in electronic communication with a computer server 314.

Accounting, practice management, bookkeeping and customer management software programs 316 can reside on the local computer network, such as on one or more work stations and/or servers, and can be accessible to the work stations 312 and the server 314. A user can access the accounting, practice management and other programs 316 through the clients 312 to input data, such as financial transactions and customer information into the programs.

A monitoring software program 318 can also reside on or be accessible to the local computer network. In one embodiment, the monitoring software program can reside on the local computer server 314. The monitoring software program 318 can interface with the accounting and other software programs to watch for and record unusual transaction activity. In another embodiment, the monitoring software may be remote or outside of the local computer network, but have access to the local computer network to monitor transaction activity. In this embodiment, the monitoring software can be configured to receive permissions from the network and/or local computer. The monitoring software can also be configured to bypass network or computer firewalls and so forth to access and monitor the data.

The monitoring program 318 can upload the recorded transaction data to a web application 332. The web application 332 can reside on an internet accessible computer network 330. The internet accessible computer network 330 can include at least one web server 334, application server 336 and database server 338. The web application can include a graphical user interface (GUI) to enable a responsible party to view the monitored data as desired. In one aspect, the GUI can also provide a dashboard having a plurality of regions for displaying different groups of data. For example, the dashboard may comprise four quadrants: one for displaying suspicious activity, one for practice information, one for production statistics, and one for accounts receivable. For example, the suspicious activity category can list specific activities and can categorize the activities according to an activity type. The practice specific information can include information such as a total number of patients, a number of patient visits completed during a time frame (e.g., a day, a month, etc.), patients who missed visits, and so forth.

The web application can include security measures, such as providing a login screen for receiving a username and password, to ensure that the data accessible through the web application is secure. In one aspect, logging in to the web application can enable the responsible party to see real-time data as the data is monitored. The web application can also monitor to ensure that the monitoring program is timely uploading the recorded transaction data to the web application. If, for example, the monitoring program has failed to upload transaction data within a predetermined time frame, the responsible party can be alerted when the responsible party accesses the web application.

The web application 332 can compare and review the uploaded transaction data and notify a responsible party if questionable transaction data exists that needs to be resolved. For example, the web application 332 can notify the responsible party via wireless or landline telephone 340 using recorded voice messages, text messages, voice mail messages, or other telephonic messaging methods, as known in the art. Additionally, the web application 332 can notify the responsible party via a computer work station 342 by email message, instant message, or other electronic message means, as known in the art. According to an embodiment, the system provides differing standards for how and when to contact the responsible party to notify the responsible party of unusual activity. For example, the nature or degree of unusual activity may determine whether notification is immediate or delayed (e.g., until the end of the day). Also, the nature or degree of unusual activity may determine how the notification is provided. For example, certain unusual activity may result in immediate telephone notification while other unusual activity may result in delayed email notification.

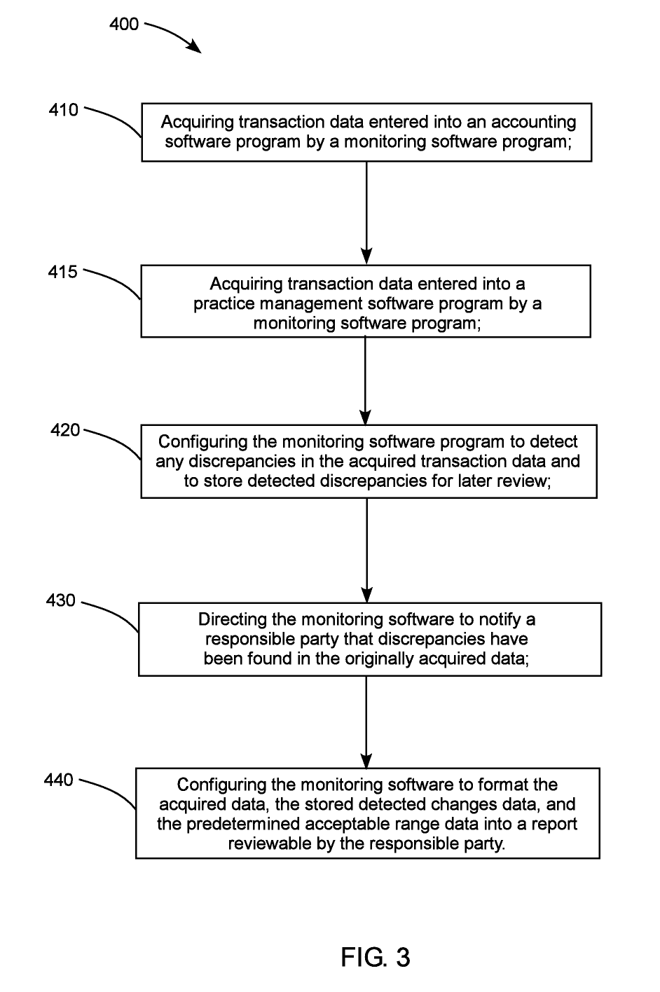

An embodiment of a method, illustrated in FIG. 3 and indicated generally at 400, is provided for detecting fraudulent transactions and help businesses track accounts receivable and other financial transactions. The method includes acquiring transaction data entered into an accounting software program by a monitoring software program, as shown at 410. The method can further include acquiring transaction data entered into a practice management software program by a monitoring software program, as shown at 415. The monitoring software program can be configured to detect unusual activity in the acquired transaction data and to store detected unusual activity for later review, as shown at 420. The monitoring software can be directed to notify a responsible party that unusual activity has been found in the originally acquired data, as shown at 430. The monitoring software can also be configured to format the acquired data and the data of the unusual activity into a report reviewable by the responsible party, as shown at 440.

The method can also include installing the monitoring software onto a computer system used to enter transactions into an accounting or practice management software program. Additionally, an operating system for the computer system can be directed to activate and run the monitoring software upon startup of the computer system and to run the monitoring software continuously in the background during use of the computer system. In one embodiment, the accounting software, practice management software, and the monitoring software may all be installed on a server. In another embodiment, the accounting, practice management and monitoring software may all be installed on a workstation. In yet another embodiment, one of the accounting and monitoring software may be installed on a workstation, and the other of the accounting and monitoring software may be installed on a server.

The operations of acquiring transaction data 410, 415 can include interfacing the monitoring software program with the accounting software program or practice management software program to provide access to the data entered into the accounting software program or practice management software program by the monitoring software program. The acquired transaction data can include key fraud indicators such as date change, service amount change, service code change, deposit amount change, etc. Fraud indicators may more generally be deleted or modified transactions or entries.

The operation of detecting discrepancies 420 can also include detecting and recording changes made in the entered data after an initial entry in the accounting software program or practice management software program. Additionally, discrepancies can be detected by comparing and recording differences between the entered data and a predetermined acceptable range of values. The predetermined acceptable range can be determined by a fee per service schedule set forth by a responsible party, such as the business proprietor, an insurance company, and the like.

The operation of notifying a responsible party 430 can include sending an electronically transmitted message such as an email, instant message, text message, voice message, and/or combinations thereof. Additionally, the operation of notifying a responsible party can include providing the responsible party with instructions to review the acquired data and the stored detected changes data and to resolve discrepancies, if differences are found between the acquired data, the stored detected changes data, and a predetermined acceptable range of values determined by a fee per service schedule. The operation of notifying a responsible party can also include notifying the responsible party that no discrepancies have been found.

The method can also include configuring the monitoring software to allow the responsible party to direct the monitoring software to populate an affidavit and police report with the acquired data, the stored detected changes data, and the predetermined acceptable range data.

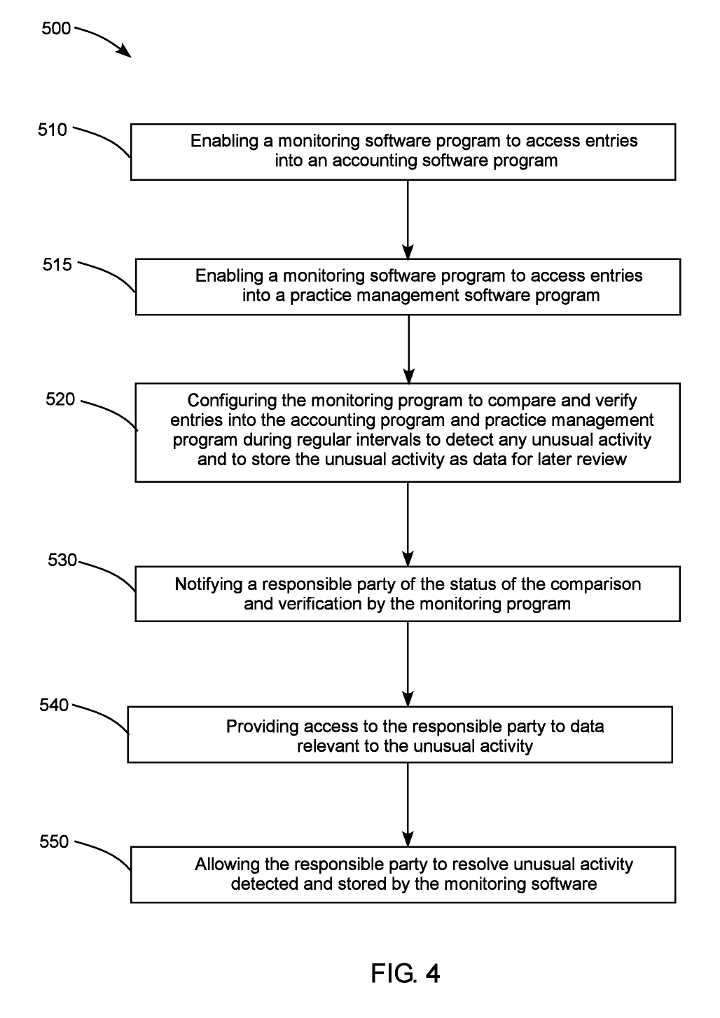

As illustrated in FIG. 4 and indicated generally at 500, the present invention also provides a method for detecting fraudulent transactions, including enabling a monitoring software program to access entries into an accounting database and/or software program, as shown at 510. Further, the monitoring software program can be enabled to access entries into a practice management database and/or software program, as shown at 515. The monitoring program can be configured to compare and verify entries into the accounting database/program and/or practice management database/program during regular intervals to detect any unusual activity and to store the unusual activity as data for later review, as shown at 520. A responsible party can be notified of the status of the comparison and verification by the monitoring program, as shown at 530. The responsible party can access data relevant to the unusual activity, as shown at 540, and the responsible party can be allowed to resolve unusual activity detected and stored by the monitoring software, as shown at 550.

The operation of notifying the responsible party can include sending a message to the responsible party that no unusual activity has been detected. Additionally, when unusual activity is detected, the operation of notifying the responsible party can include sending a message to the responsible party that the stored unusual activity data needs to be reviewed.

The method can also include configuring the monitoring program to organize data from the accounting and practice management programs into categories such as aging accounts receivable, top procedures performed, client vitae, unusual activity as detected throughout a monitoring period, and combinations thereof.

The operation of providing access to the responsible party to data relevant to the unusual activity can include identifying employees who entered the data, and identifying types of transactions involved in the unusual activity. Additionally, the operation of allowing the responsible party to resolve the unusual activity can include deleting unusual transaction data if desired, and saving unusual transaction data for later use if unusual activity is unresolvable.

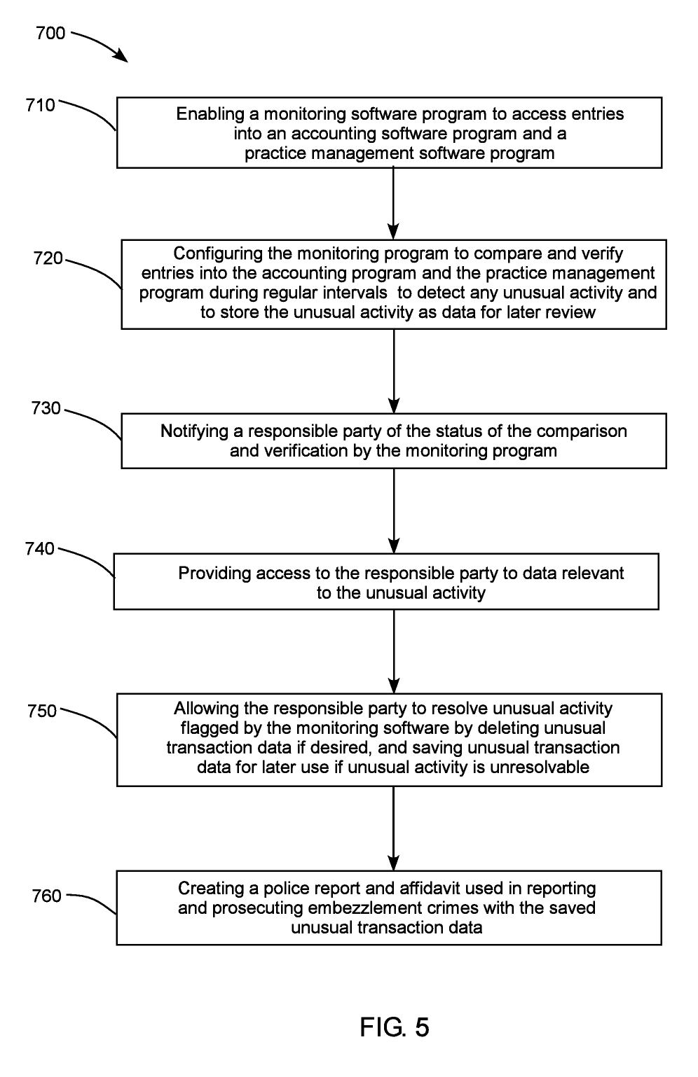

As illustrated in FIG. 5, the present invention also provides a method for detecting fraudulent transactions, indicated generally at 700, including enabling a monitoring software program to access entries into an accounting software program and a practice management software program, as shown at 710. The monitoring program can be configured to compare and verify entries into the accounting program and practice management program during regular intervals to detect any unusual activity and to store the unusual activity as data for later review, as shown at 720. A responsible party can be notified of the status of the comparison and verification by the monitoring program, as shown at 730. Access can be provided to the responsible party to data relevant to the unusual activity, as shown at 740. The responsible party can be allowed to resolve unusual activity flagged by the monitoring software by deleting unusual transaction data if desired, and saving unusual transaction data for later use, if the unusual activity is unresolvable, as shown at 750.

The operation of creating a police report and affidavit can include accessing a report wizard in the monitoring software program. A police report and affidavit used in reporting and prosecuting embezzlement crimes can be created with the saved unusual transaction data, as shown at 760.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A method for detecting fraudulent transactions; comprising:
acquiring transaction data entered into an accounting software program by a monitoring software program;
acquiring transaction data entered into a practice management software program by a monitoring software program;
configuring the monitoring software program to detect any unusual activity in the acquired transaction data and to store detected unusual activity for later review;
directing the monitoring software to notify a responsible party that unusual activity has been found in the originally acquired data; and
configuring the monitoring software to format the acquired data and the data of the unusual activity into a report reviewable by the responsible party.

2. A method in accordance with claim 1, wherein the operation of acquiring transaction data further includes interfacing the monitoring software program with the accounting software program and the practice management software program to provide access to the data entered into the accounting software program and the practice management software program by the monitoring software program.

3. A method in accordance with claim 1, wherein the acquired transaction data includes key fraud indicators selected from the group consisting of: date change, service amount change, service code change, deposit amount change, deleted transactions, deleted entries, modified transactions, modified entries, and combinations thereof.

4. A method in accordance with claim 1, wherein the operation of detecting discrepancies includes detecting and recording changes made in the entered data after an initial entry in the accounting software program or the practice management software program.

5. A method in accordance with claim 1, wherein the operation of detecting discrepancies includes comparing and recording differences between the entered data and a predetermined acceptable range of values.

6. A method in accordance with claim 5, wherein the predetermined acceptable range is determined by a fee per service schedule.

7. A method in accordance with claim 1, wherein the operation of notifying a responsible party includes sending an electronically transmitted message selected from the group consisting of an email, an instant message, a text message, a voice message, and combinations thereof.

8. A method in accordance with claim 1, wherein the operation of notifying a responsible party includes providing the responsible party with instructions to review the acquired data and the stored detected changes data and resolve discrepancies if differences are found between the acquired data, the stored detected changes data, and a predetermined acceptable range of values determined by a fee per service schedule.

9. A method in accordance with claim 1, further comprising:
configuring the monitoring software to allow the responsible party to direct the monitoring software to populate an affidavit and police report with the acquired data, the stored detected changes data, and the predetermined acceptable range data.

10. A method in accordance with claim 1, further comprising notifying the responsible party that no discrepancies have been found.

11. A method for detecting fraudulent transactions; comprising:
a) enabling a monitoring software program to access entries into an accounting software program;
b) enabling a monitoring software program to access entries into a practice management software program;
c) configuring the monitoring program to compare and verify entries into the accounting program and practice management program during regular intervals to detect any unusual activity and to store the unusual activity as data for later review;
d) notifying a responsible party of the status of the comparison and verification by the monitoring program;
e) providing access to the responsible party to data relevant to the unusual activity; and
f) allowing the responsible party to resolve unusual activity detected and stored by the monitoring software.

12. A method in accordance with claim 11, wherein the operation of notifying the responsible party includes sending a message to the responsible party that no unusual activity has been detected.

13. A method in accordance with claim 11 wherein the operation of notifying the responsible party includes sending a message to the responsible party that the stored unusual activity data needs to be reviewed if unusual activity is detected.

14. A method in accordance with claim 11, further comprising configuring the monitoring program to organize data from the accounting program and the practice management program into categories selected from the group consisting of aging accounts receivable, top procedures performed, client vitae, unusual activity as detected throughout a monitoring period, and combinations thereof.

15. A method in accordance with claim 11, wherein the operation of providing access to the responsible party of data relevant to the unusual activity includes identifying employees who entered the data, and identifying types of transactions involved in the unusual activity.

16. A method in accordance with claim 11, wherein the operation of allowing the responsible party to resolve the unusual activity includes deleting unusual transaction data if desired, and saving unusual transaction data for later use if unusual activity is unresolvable.

17. A method in accordance with claim 16, further comprising:
creating a police report and affidavit used in reporting and prosecuting embezzlement crimes with the saved unusual transaction data.

18. A method for detecting fraudulent transactions; comprising:
a) enabling a monitoring software program to access entries into an accounting software program;
b) enabling a monitoring software program to access entries into a practice management software program;
b) configuring the monitoring program to compare and verify entries into the accounting program and the practice management program during regular intervals to detect any unusual activity and to store the unusual activity as data for later review;
c) notifying a responsible party of the status of the comparison and verification by the monitoring program;
d) providing access to the responsible party to data relevant to the unusual activity;
e) allowing the responsible party to resolve unusual activity flagged by the monitoring software by deleting unusual transaction data if desired, and saving unusual transaction data for later use if unusual activity is unresolvable; and
f) creating a police report and affidavit used in reporting and prosecuting embezzlement crimes with the saved unusual transaction data.

19. A method in accordance with claim 18, wherein the operation of creating a police report and affidavit further includes accessing a report wizard in the monitoring software program.

20. A method in accordance with claim 18, wherein notifying a responsible party further comprises determining a type or degree of the unusual activity to determine whether to immediately notify the responsible party or to delay notifying the responsible party.
